(19) United States
(12) Patent Application Publication
(10) Pub. No.: US 2010/0229184 A1
(43) Pub. Date: Sep. 9, 2010

(54) SYSTEM MANAGEMENT APPARATUS

(76) Inventors: Shunji Satou, Osaka (JP); Satoshi Inami, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/294,474

(22) PCT Filed: Mar. 28, 2007
(86) PCT No.: PCT/JP2007/056582

§ 371 Date: Sep. 25, 2008

(30) Foreign Application Priority Data
Apr. 5, 2006 (JP) 2006-103770

(51) Int. Cl. G06F 9/44

(52) U.S. Cl. 719/318

(57) ABSTRACT

A system management apparatus (101) includes: a start-judgment unit (104) that obtains an event identifier for identifying an event from an event storage unit (103) in which an event for an application program is stored; a status obtainment unit (106) that obtains a status of the information processing system; and a control unit (107) that adaptively starts the application program. The start-judgment unit (104) judges whether or not to start the application program according to whether or not the status of the information processing system obtained by the status obtainment unit (106) satisfies a start judgment condition associated with the event identifier. The control unit (107), when the start-judgment unit (104) judges that the application program is not to be started, discards the event stored in the event storage unit (103) without starting the application program.

### TECHNICAL FIELD

The present invention relates to a system management apparatus that manages an operation of an information processing system.

### BACKGROUND ART

Information processing systems, such as mobile terminals, are conventionally capable of executing plural application programs and are provided with an application status storage unit in which an operational status of each of the application programs is stored.

Such a mobile terminal is capable of identifying an application program that corresponds to an event that has occurred according to a button operation by a user and the like, and determining whether or not to start the application program corresponding to the received event based on a predetermined competitive condition between plural application programs.

Further, in the case where it has been determined to start the application program, an operational status of application programs other than the application program is read out from the application status storage unit, application programs in operation are stopped, and the application program is started.

As described above, in an environment with limited memory capacity, start of plural application programs has been controlled and techniques concerning such a control have been disclosed (see, for example, Patent Reference 1).

### Patent Reference 1: Japanese Unexamined Patent Application Publication No. 2005-284906

### DISCLOSURE OF INVENTION

### Problems that Invention is to Solve

Here, with the above conventional technique, start-judgment of an application program is carried out based on a state of each application program and a competitive condition of each application program when an event occurs.

Further, after starting the application program that has been judged to be started, an event notification is received and processing is to be carried out by judging details of the event.

In other words, in an information processing system such as mobile terminals, an application program is started even in the case where an event occurs that is to be subsequently judged unnecessary to start the application program.

To be specific, the application program is stopped after started and the details of the event have been judged, without carrying out processing corresponding to the event.

With this, resources such as memory and electric power that have actually no need to be consumed are unnecessarily consumed.

As described above, with the above conventional techniques, it is possible to control plural application programs that exist in the information processing system so as not to compete against each other.

However, problems such as starting application programs that have actually no need to be started cannot be solved.

The present invention has been conceived in view of the above-described conventional problem and aims to present a system management apparatus that makes an application program work efficiently in an information processing system.

### Means to Solve the Problems

In order to achieve the object described above, the system management apparatus according to the present invention is a system management apparatus which manages an information processing system capable of executing an application program, the system management apparatus includes: an event obtainment unit that obtains, from a storage unit in which an event corresponding to the application program is stored, an event identifier that identifies the event, the storage unit being included in the information processing system; a status obtainment unit that obtains a status of the information processing system; a control unit that adaptively starts the application program; and a judgment unit that judges whether or not to start the application program depending on whether or not the obtained status of the information processing system satisfies a start-judgment condition associated with the obtained event identifier, in which the control unit discards the event stored in the storage unit without starting the application program in the case where the judgment unit judges that the application program is not to be started.

This enables, when an event occurs in the information processing system, judging whether or not to start an application program which is to be notified of the event before the application program is started.

More specifically, it is possible, when an event occurs which has no need to start an application program, to discard the event without unnecessarily starting the application program.

Further, the system management apparatus according to the present invention may include a monitoring unit that detects that the event has been stored in the event storage unit, in which the judgment unit judges whether or not to start the application program, when notified by the monitoring unit that the event has been stored in the event storage unit.

This enables, in the information processing system, reducing processes for notifying the system management apparatus of an event occurrence from a middleware, thereby shortening processing time.

Further, the present invention may be embodied as an integrated circuit including the characteristic components of the system management apparatus according to the present invention.

Further, the present invention may be embodied as a method including, as its steps, operations of the characteristic components of the system management apparatus according to the present invention, and as a program including the steps.

Further, the present invention may be embodied as recording medium such as CD-ROM and an integrated circuit, in which the program is stored. The program may be distributed via transmission medium such as a communication network.

### EFFECTS OF THE INVENTION

With the system management apparatus according to the present invention, it is possible to judge whether or not to start an application program which is to be notified of the event, for each event occurred, according to a state of the information processing system, in other words, to judge whether start is necessary or not.

Further, it is possible, in the case where it is judged that start of application program is unnecessary for an event that has occurred, to discard the event without starting the application program. This enables reducing load in the system, thereby making an application program work efficiently.

### BRIEF DESCRIPTION OF DRAWINGS

FIG. 1 is a functional block diagram illustrating a major functional configuration of a mobile terminal according to a first embodiment.

FIG. 2 is an example of a data structure of an event according to the first embodiment.

FIG. 3 is a diagram illustrating an example of a start-judgment condition according to the first embodiment.

FIG. 4 is a flowchart illustrating operations of a start-judgment of a system management apparatus according to the first embodiment.

FIG. 5 is a diagram illustrating an example of a start-judgment condition after an update according to the first embodiment.

FIG. 6 is a diagram illustrating another example of a start-judgment condition according to the first embodiment.

FIG. 7 is a diagram illustrating an example of a start-judgment condition after an update according to the first embodiment.

FIG. 8 is a functional block diagram illustrating a major functional configuration of a mobile terminal according to a second embodiment.

FIG. 9 is a flowchart illustrating operations of a start-judgment of a system management apparatus according to the second embodiment.

FIG. 10 is a diagram illustrating an example of an integrated circuit used for a system management apparatus according to the first embodiment.

### NUMERICAL REFERENCES

10, 20 mobile terminal
101, 201 system management apparatus
102 middleware
103, 203 event storage unit
104, 204 start-judgment unit
105 condition storage unit
106, 206 status obtainment unit
107 control unit
108 application program
202 monitoring unit
300 LSI

### BEST MODE FOR CARRYING OUT THE INVENTION

A system management apparatus according to embodiments of the present invention will be described below with reference to the drawings.

### First Embodiment

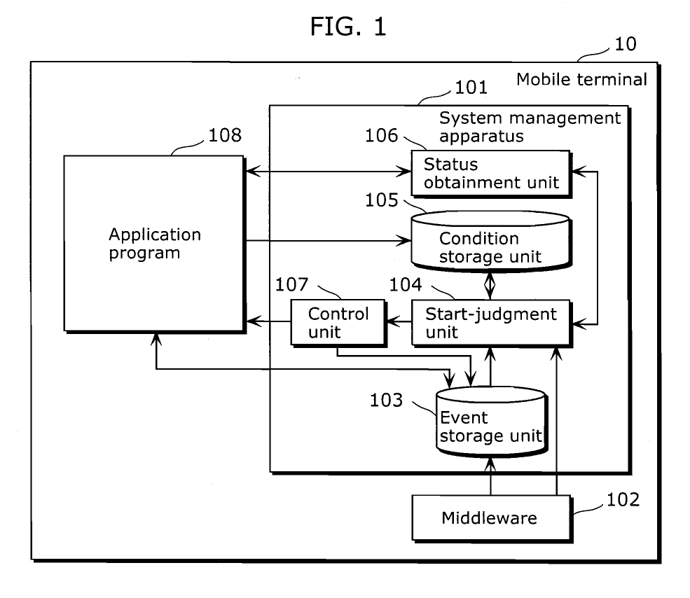

First, a configuration of a mobile terminal 10 provided with a system management apparatus 101 according to a first embodiment of the present invention will be described with reference to FIG. 1 to FIG. 3.

FIG. 1 is a functional block diagram illustrating a major functional configuration of the mobile terminal 10 according to a first embodiment of the present invention.

The mobile terminal 10 as illustrated in FIG. 1 is an example of an information processing system that is to be managed by the system management apparatus of the present invention, and is a mobile terminal including plural applications software.

As illustrated in FIG. 1, the mobile terminal 10 according to a first embodiment includes: the system management apparatus 101; a middleware 102; and an application program 180.

It is to be noted that the mobile terminal 10 includes other software and hardware such as an execution environment for executing the application program 108, a function for communicating with other devices, a camera for shooting a still image and a moving image, and a tuner for receiving TV programs. However, illustrations and descriptions of them are omitted in order to clarify the features of the present invention, and functional configurations which are characteristic to the present invention will be illustrated and described.

Further, the mobile terminal 10 includes equal to or more than one application programs, and the application program 108 is illustrated as a representative. It is assumed that in the case where “application program” is indicated below, it indicates one of the equal to or more than one application programs included by the mobile terminal 10.

The system management apparatus 101 is an apparatus that manages and controls operations of equal to or more than one application programs included by the mobile terminal 10.

More specifically, the system management apparatus 101 receives an event from the middleware 102 when an event notification from the middleware 102 to the application program occurs. Further, the application program corresponding to the received event is judged and a start of the application program is controlled. Further, processes such as notifying the started application program of a necessary event is carried out.

The system management apparatus 101 includes, as the configuration for performing such processes, an event storage unit 103, a start-judgment unit 104, a condition storage unit 105, a status obtainment unit 106, and a control unit 107.

The event storage unit 103 is a storage device in which an event corresponding to the application program transmitted from the middleware 102 is temporarily stored.

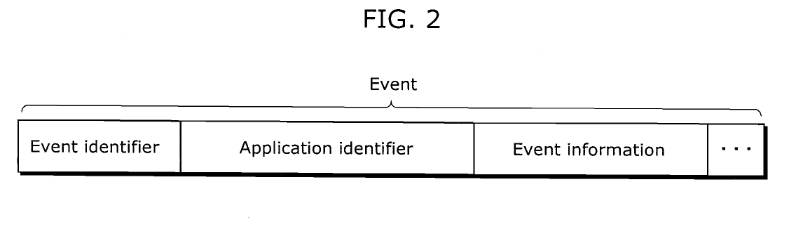

It is to be noted that the event according to the present embodiment includes an event identifier, an application identifier, and event information as illustrated in FIG. 2.

The event identifier is information for identifying an event, and the application identifier is information for identifying an application program which is to be notified of the event, in other words, the application program that is to process the event.

Further, the event information is data to be used when the application program indicated in the application identifier processes the event.

For example, in the case where a button for starting movie shooting is pressed by a user, an event that includes: an application identifier indicating an application program for controlling a camera and the like (hereinafter referred to as “camera application”); an event identifier indicating “movie shooting”; and event information including information indicating the button pressed by the user, is transmitted from the middleware 102 to the system management apparatus 101.

The start-judgment unit 104 is a processing unit that judges whether or not to start the application program.

More specifically, when receiving a notification of an event occurrence from the middleware 102, the start-judgment unit 104 judges whether or not to start the application program which is to be notified of the event, based on whether or not a state of the mobile terminal 10, which has been obtained by the status obtainment unit 106, satisfies a start-judgment condition associated with the event identifier obtained from the event storage unit 103.

It is to be noted that the start-judgment unit 104 is an example of an event obtainment unit according to the system management apparatus of the present invention.

The condition storage unit 105 is a storage device that stores a start-judgment condition associated with a corresponding one of event identifiers of plural types. The start-judgment condition is information indicating a status of the mobile terminal 10, the status being a condition for whether or not to start the application program.

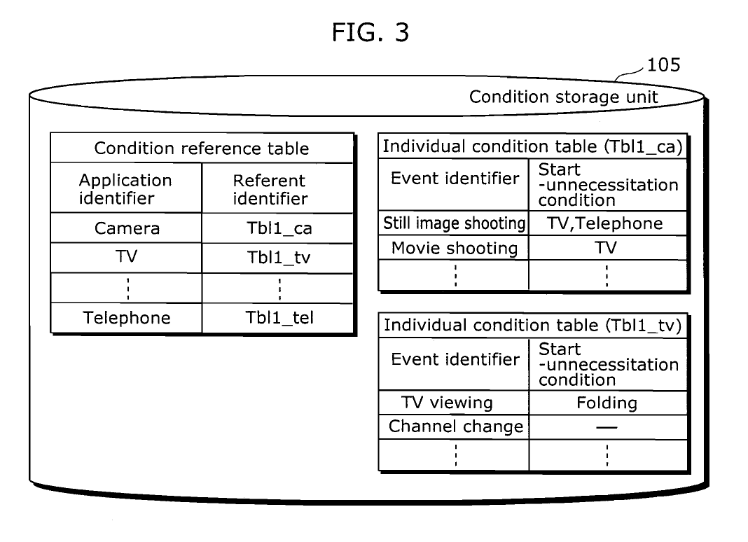

In the present embodiment, information indicating a state of the above mobile terminal 10 is the information indicating an operational status of a predetermined application program. Details of the start-judgment condition will be described later with reference to FIG. 3 and so on.

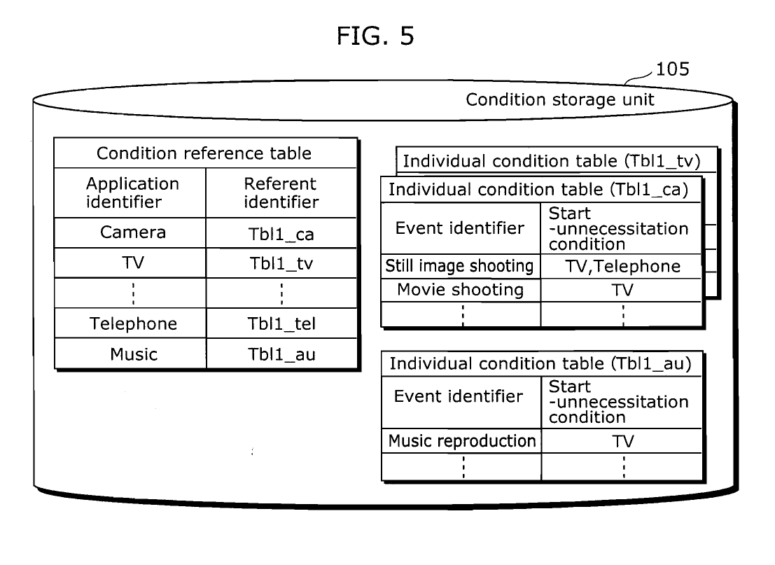

Further, the condition storage unit 105, when an application program is added to the mobile terminal 10, stores the start-judgment condition regarding the application program according to a request from the application program. In other words, the condition storage unit 150 is capable of updating the start-judgment condition. A specific example of the update will be described later with reference to FIG. 5.

The status obtainment unit 106 is a processing unit that obtains a state of the mobile terminal 10. The status obtainment unit 106 obtains an operational status of each application program as the state of the mobile terminal 10 in the present embodiment.

More specifically, when receiving a request for obtaining the operational status of the application program from the start-judgment unit 104, the status obtainment unit 106 notifies each of the application programs of the request for obtaining the operational status.

Further, the status obtainment unit 106 obtains each operational status transmitted from each application program, and notifies the start-judgment unit 104 of these operational statuses as a response to the request for obtainment.

The start-judgment unit 104 is a processing unit that judges whether or not to start the application program which is to be notified of the event, based on the operational status of each application program obtained from the status obtainment unit 106 and the start-judgment condition associated with the event identifier obtained from the event storage unit 103, and notifies the control unit 107 of a result of the judgment.

The control unit 107 is a processing unit that adaptively starts an application program based on a result of the judgment of the start-judgment unit 104.

More specifically, in the case where the control unit 107 is notified, by the start-judgment unit 104, of a result of the judgment indicating that an application program to be notified of the event is not to be started, the control unit 107 discards the event stored in the event storage unit 103 without starting the application program to be notified of the event.

Also, the control unit 107, in the case where the control unit 107 is notified, by the start-judgment unit 104, of a result of the judgment indicating that an application program to be notified of the event is to be started, the control unit 107 starts the application program and notifies the application program of an event identifier.

The application program started and notified of the event identifier by the control unit 107 reads event information out of the event storage unit 103 based on the event identifier and performs a process using the event information.

FIG. 3 is a diagram illustrating an example of a start-judgment condition according to the first embodiment.

As illustrated in FIG. 3, the start-judgment condition according to the present embodiment includes two types of tables; that is, a condition reference table and an individual condition table.

More specifically, the condition reference table is a table in which an application identifier and a referent identifier are recorded in association with each other.

The referent identifier is an identifier that identifies the individual condition table to be referred when start-judgment for the application program identified by the application identifier is carried out.

The individual condition table is a table in which an event identifier and a start-unnecessitation condition are recorded in association with each other, and each application program has an individual condition table in one-to-one association.

The start-unnecessitation condition is a condition for making start of the application program corresponding to the individual condition table unnecessary.

More specifically, when an operational status of the application program indicated by the start-unnecessitation condition is “in operation”, it indicates that the application program on which start-judgment is to be carried out (hereinafter referred to as “to-be-judged application”) does not need to be started.

The start-judgment unit 104 identifies, by referring to the condition reference table, the individual condition table corresponding to the application program to be notified of the event. Further, the start-judgment unit 104 identifies, by referring to the identified individual condition table, the start-unnecessitation condition associated with the event identifier.

Further, the start-judgment unit 104 judges whether start is necessary or unnecessary based on the identified start-unnecessitation condition and the operational status of each of the application programs received from the status obtainment unit 106.

In the start-judgment condition as illustrated in FIG. 3 includes a condition that, for example, when an event of movie shooting is transmitted from the middleware 102, a camera application to be notified of the event of movie shooting does not need to be started in the case where the application program of television (TV) (hereinafter referred to as “TV application”) is in operation.

It is to be noted that, regarding the start-judgment, when an application program (the TV application, in the above case) is “in operation”, it is not limited to the case where the application program is actually performing a certain process and the case where the application program is displaying or outputting certain information onto an interface such as a display unit and the like (such a state is referred to as “active”).

For example, the case is also included where, on the display unit, the application program is in a state that a screen display of the application program is hidden by another application program that is active and capable of immediately displaying on the screen with a predetermined operation (such a state is referred to as “inactive”).

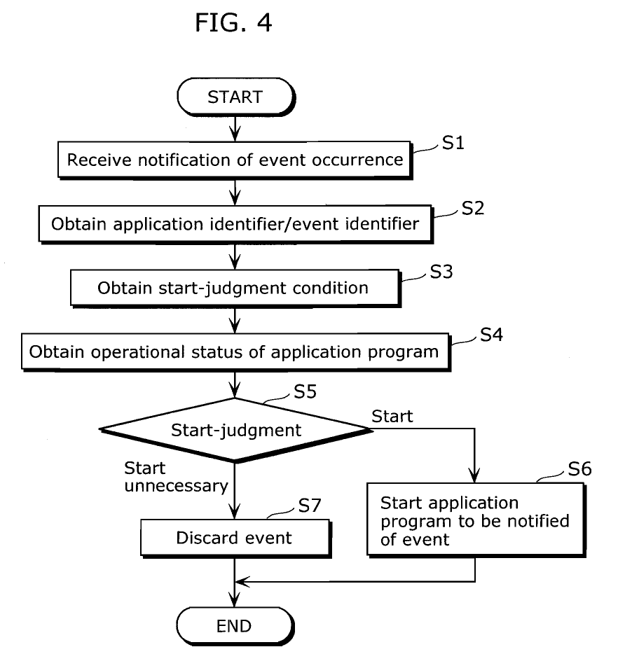

Next, operations of the system management apparatus 101 according to the first embodiment of the present invention will be described with reference to FIG. 4 to FIG. 7.

FIG. 4 is a flowchart illustrating operations of an start-judgment of a system management apparatus 101 according to the first embodiment.

First, when an event is transmitted from the middleware 102, the event is stored in the event storage unit 103. The start-judgment unit 104 receives, at this time, a notification of event occurrence from the middleware 102 (S1).

When the notification of event occurrence is received, the start-judgment unit 104 obtains an application identifier and an event identifier from the event storage unit 103 (S2).

The start-judgment unit 104 obtains an start-judgment condition associated with the application identifier and the event identifier that have been obtained from the condition storage unit 105 (S3).

More specifically, the start-judgment unit 104 identifies, by referring to the condition reference table, an individual condition table associated with the application identifier. Further, the start-judgment unit 104 identifies, by referring to the identified individual condition table, the start-unnecessitation condition corresponding to the event identifier.

Further, the start-judgment unit 104 obtains an operational status of one or more than one application program from the status obtainment unit 106 (S4).

It is to be noted that, an operational status of the application program associated with the application identifier; that is, the to-be-judged application is also obtained at this time. Further, since start-judgment is not necessary in the case where the to-be-judged application has already been started, the operation that relates to start-judgment is terminated. Further, the to-be-judged application obtains the event from the event storage unit 103 and processes the event.

The start-judgment unit 104 performs start-judgment on the application program to be notified of the event based on the obtained start-judgment condition and the operational status of one or more than one application program (S5).

More specifically, judgment is carried out based on whether or not the application program indicated by the start-unnecessitation condition is in operation.

In the case where the application program indicated by the start-unnecessitation condition is not in operation, it is judged that the to-be-judged application is to be started (start, in S5) and the result of the judgment is notified to the control unit 107.

On the other hand, in the case where the application program that satisfies the start-unnecessitation condition is in operation, it is judged that the to-be-judged application is not to be started (start unnecessary, in S5) and the result of the judgment is notified to the control unit 107.

The control unit 107, in the case where the notification of “start” is received from the start-judgment unit 104, starts the application program indicated by the application identifier; that is, the application program to be notified of the event (S6).

Further, in the case where the notification of “start unnecessary” is received from the start-judgment unit 104, the control unit 107 discards the event stored in the event storage unit 103 without starting the application program to be notified of the event (S7).

The operation that relates to the start-judgment of the system management apparatus 101 as described above will be described in detail using the start-judgment condition as illustrated in FIG. 3.

It is to be noted that a case where the middleware 102 transmits an event of movie shooting is assumed. Further, an application program which is to be notified of the event of movie shooting is a camera application. More specifically, the event includes an application identifier that indicates the camera application and an event identifier that indicates the “movie shooting”.

The event of movie shooting is transmitted from the middleware 102 and stored in the event storage unit 103. Further, the start-judgment unit 104 receives a notification of event occurrence from the middleware 102 (S1).

When the notification of event occurrence is received, the start-judgment unit 104 obtains an application identifier that indicates a camera application and an event identifier that indicates a “movie shooting” from the event storage unit 103 (S2).

The start-judgment unit 104, when these identifiers are obtained, obtains an start-unnecessitation condition associated with these identifiers from the condition storage unit 105 (S3).

More specifically, “tbl1_ca” that is associated with “camera” is identified from the condition reference table and “TV” that is the start-unnecessitation condition associated with “movie shooting” is obtained from the individual condition table of “tbl1_ca”.

Further, the start-judgment unit 104 obtains an operational status of one or more than one application program at the time from the status obtainment unit 106. In the case of this example, the start-judgment unit 104 obtains that the TV application is currently in operation. (S4)

The start-judgment unit 104 judges that the camera application is not to be started, since the obtained operational status satisfies the start-unnecessitation condition; that is, the TV application being in operation. (start unnecessary, in S5).

The control unit 107 receives a result of the judgment and discards the event of movie shooting stored in the event storage unit 103 without starting the camera application.

As described above, the system management apparatus 101 according to the present embodiment, when an event occurs in the information processing system, judges whether or not to start an application program which is to be notified of the event.

More specifically, the system management apparatus 101 judges, for each event that occurs corresponding to a certain application, whether or not to start an application program which is to be notified of the event according to an operational status of one or more than one application program at the time in the information processing system.

Here, in conventional information processing systems, whether or not to start is not judged for each event. For that reason, when an event occurred in the information processing systems, start is judged to be unnecessary, according to processing details indicated by the event, in some cases after the application program which is to be notified of the event has been started.

Even in such a case, however, the system management apparatus 101 according to the present embodiment avoids starting the application program which is to be notified of the event by carrying out the above start-judgment.

More specifically, it is possible to immediately discard the event without unnecessarily starting the application program.

As described above, the system management apparatus 101 according to the present embodiment can make an application program work efficiently in the information processing system, thereby reducing processing load of the information processing system. Further, it is possible to make the information processing system efficiently use memory and the like in which an event is to be stored.

There is a further advantage that a performance of electric power consumption is increased by reducing load in the information processing system.

Further, in the case where an application program is added to the information processing system, a table corresponding to the application program is added to each of the condition reference table and the individual condition table.

FIG. 5 is a diagram illustrating an example of a start-judgment condition after an update according to the first embodiment.

It is to be noted that, as an example of the case where an application program is added to the mobile terminal 10, a new application program is installed into the mobile terminal 10, by downloading the new application program via a network.

Further, there is a case where an application program is added to the mobile terminal 10 by inserting, into the mobile terminal 10, an external storage medium such as a secure digital (SD) card in which the application program is stored.

Further, FIG. 5 illustrates a start-judgment condition in the case where an application program for reproducing audio data (hereinafter referred to as “music application”) is added to the mobile terminal 10.

In the case where a music application is added to the mobile terminal 10, a start-judgment condition for the music application is recorded, in response to a request from the music application, on the condition storage unit 105 at a predetermined timing such as when the music application is installed or is started for the first time.

More specifically, “music” is added to the condition reference table as an application identifier and “Tbl1_au” is added as a referent identifier associated with “music” as illustrated in FIG. 5.

Further, an individual condition table “Tbl1_au” indicated by the referent identifier is added to the condition storage unit 105.

It is to be noted that, “music” is added, when necessary, to each individual condition table associated with each application program other than the music application, as an start-unnecessitation condition.

According to the example illustrated in FIG. 5, in the case where an event of “music reproduction” for the music application occurs in the mobile terminal 10 due to a button operation and the like by a user, the start-judgment unit 104 obtains “TV” that is a start-unnecessitation condition.

The start-judgment unit 104, accordingly, judges that it is unnecessary to start the music application, in the case where information of the TV application being in operation is obtained from the status obtainment unit 106. Further, the control unit 107 discards the event stored in the event storage unit 103 without starting the music application in response to a result of the judgment.

As described above, the system management apparatus 101 updates the start-judgment condition, so that, even when an application program is added, the system management apparatus 101 can appropriately carry out start-judgment for the added application program.

It is to be noted that, in the case where an application program is deleted, the start-judgment condition regarding the application program may be deleted from the condition storage unit 105, for example, in response to a request, from the application program to be deleted, for deletion to the condition storage unit 105.

For further example, the control unit 107 may detect deletion of the application program and delete the start-judgment condition regarding the application program from the condition storage unit 105.

Here, the start-judgment condition to be used when the system management apparatus 101 performs a start-judgment may be in a format other than the formats illustrated in FIG. 3 and FIG. 5.

More specifically, when it is possible to judge, for each event that occurs in the information processing system, whether or not to start an application program to be notified of an event according to an operational status of the application program at the time, any other format can be applied.

The start-judgment condition, for example, may be in a format of function that can derive the start-unnecessitation condition by using the event identifier as an argument.

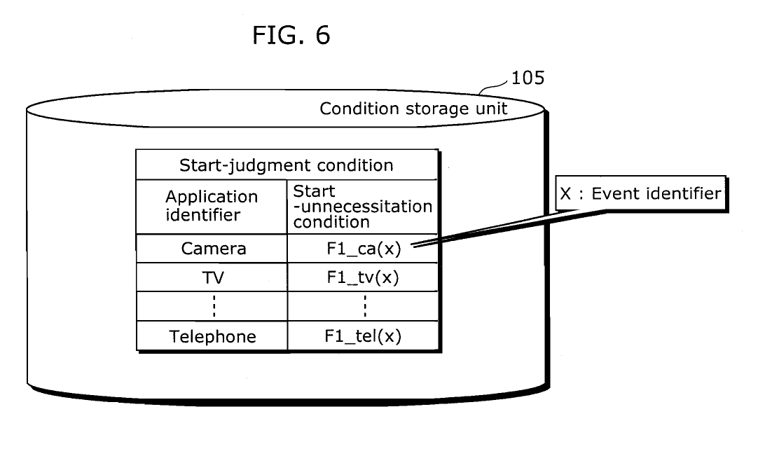

FIG. 6 is a diagram illustrating another example of an start-judgment condition according to the first embodiment.

The judgment condition table illustrated in FIG. 6 is a table in which a function that derives the start-unnecessitation condition by using the event identifier as an argument is registered for each to-be-judged application.

The start-judgment unit 104 executes a function by inputting the event identifier of the event into the argument x of the function associated with the application program to be notified of the event.

This makes it possible to obtain a condition that start of the to-be-judged application is made unnecessary as Return value of the function. Further, the start-judgment unit 104 can obtain an operational status of one or more than one application program to be necessary for judgment by issuing a request, from the function, for obtaining an operational status to the status obtainment unit 106, thereby judging whether or not to start a to-be-judged application.

A specific example in which the function illustrated in FIG. 6 is used will be described below as a start-judgment condition.

The case is assumed where, when a user is making a phone call with the mobile terminal 10 and an application program of a telephone (hereinafter referred to as “telephone application”) is running, the phone call is ended from the mobile terminal 10 due to pressing a button for ending a phone call by the user.

In this case, an event of ending a phone call is notified from the mobile terminal 10 to the telephone application and the telephone application is ended.

When the user presses the button for ending a phone call again in such a situation, the event of ending a phone call is notified from the middleware 102 to the start-judgment unit 104.

The start-judgment unit 104 executes a function by inputting the event identifier of ending a phone call into the argument x of the function “F1_tel (x)” associated with the telephone application program to be notified of the event of ending a phone call stored in the condition storage unit 105.

More specifically, the function “F1_tel (x)” having the argument x of the event identifier of ending a phone call returns information indicating “telephone application being in the idle state or generating a tone signal” as the start-unnecessitation condition.

Further, a request for obtaining an operational status is issued, from the function, to the status obtainment unit 106, the operational status of the application necessary for start-judgment is obtained, and judgment is carried out.

In the case of the present example, the operation of the telephone application has been ended by the first event of ending a phone call, the start-judgment unit 104 obtains information, from the status obtainment unit 160 as the operational status, which indicates the telephone application being in the idle state where the telephone application has been loaded into a memory and only an initialization process has been ended.

The start-judgment unit 104, accordingly, judges that it is unnecessary to start the telephone application. Further, the control unit 107 receives a result of the judgment and discards the event of ending a phone call stored in the event storage unit 103 without performing control for starting the telephone application.

Further, as another example of a start-judgment using a function, the case where a button for ending a phone call on the mobile terminal 10 is pressed by a user will be described below.

First, an event for ending a phone call that has occurred as a result of ending a phone call by a terminal of the other party is notified to the telephone application of the mobile terminal 10, and the telephone application program is ended. Further in the situation, a tone signal is generated from a speaker.

When a user presses a button for ending a phone call in this situation, the event of ending a phone call is notified to the start-judgment unit 104 from the middleware 102.

The start-judgment unit 104 executes a function by inputting the event identifier of ending a phone call into an argument x of the function “F1_tel (x)” associated with the telephone application program to be notified of the event of ending a phone call stored in the condition storage unit 105.

The start-judgment unit 104, accordingly, obtains information that indicates “telephone application is in the idle state or generating a tone signal” as the start-unnecessitation condition.

Further, a request for obtaining an operational status is issued, from the function, to the status obtainment unit 106, and the operational status of the application program necessary for start-judgment is obtained.

In the case of the present example, the start-judgment unit 104 obtains the operational status that the telephone application has been ended and is generating a tone signal from the status obtainment unit 106.

The start-judgment unit 104, accordingly, judges that it is unnecessary to start the telephone application. Further, the control unit 107 receives a result of the judgment and discards the event of ending a phone call stored in the event storage unit 103 without performing control for starting the telephone application.

As described above, the system management apparatus 101 according to the present embodiment, even when the start-judgment condition is indicated by the function, can appropriately judge, for each event that occurs, whether or not to start an application program which is to be notified of the event. More specifically, it is possible to prevent an application program from being started unnecessarily.

Further, similarly to the description regarding FIG. 5, when an application program is added to the mobile terminal 10, a new function is added to the condition storage unit 105.

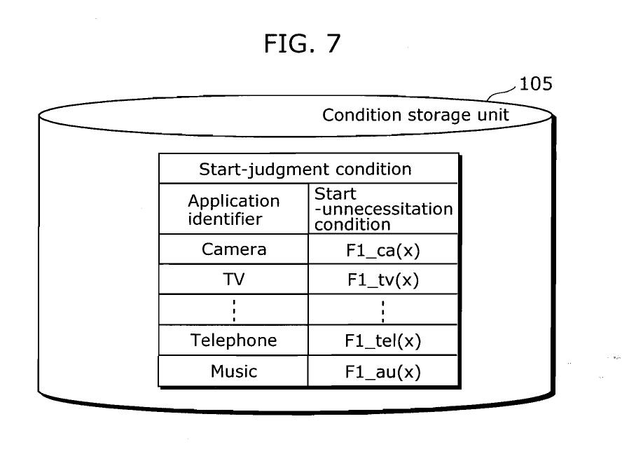

FIG. 7 is a diagram illustrating an example of a start-judgment condition after an update according to the first embodiment.

FIG. 7 illustrates a start-judgment condition in the case where a music application is added to the mobile terminal 10. More specifically, an application identifier “music” is added to the start-judgment condition illustrated in FIG. 6, and a function “F1_au (x)” is further added as the start-unnecessitation condition associated with “music”.

With this, in the case where an event corresponding to a music application, such as the event of music reproduction, has occurred from the middleware 102, the start-judgment unit 104 can identify the function “F1_au (x)” from the application identifier included in the event.

Further, it is possible to derive a condition for start of the music application to be unnecessary by inputting the event identifier indicating “music reproduction” into the argument x of “F1_au (x)” and executing it.

Further in the present embodiment, the embodiment in which the condition for start of the to-be-judged application to be unnecessary (start-unnecessitation condition) is used as the start-judgment condition has been described as illustrated in FIG. 3 and FIG. 5.

However, when performing the start-judgment in the system management apparatus 101, a condition for allowing start (start allowance condition) may be used as the start-judgment condition.

In the individual condition table “Tbl1_ca” related to the camera application (see, FIG. 3), for example, information indicating all of the application programs included in the mobile terminal 10 other than TV application is recorded not as the start-unnecessitation condition but as the start allowance condition in association with the event of the movie shooting.

With this, in the case where the application program in operation is other than the TV application, the start-judgment unit 104 can judge that the camera application is to be started.

More specifically, in the case where the TV application is in operation, the start-judgment unit 104 can judge that the camera application is not to be started. Further, in response to the result, the control unit 107 can discard the event of the movie shooting stored in the event storage unit 103.

More specifically, it is possible to obtain the same result as the start-judgment that uses the individual condition table in which the start-unnecessitation condition illustrated in FIG. 3 is recorded.

Further, even when a function that returns such a start allowance condition is used as the start-judgment condition, it is possible to obtain the same result of the judgment as the case where the function that returns the start-unnecessitation condition is used.

Further, as long as the start-judgment unit 104 can perform start-judgment for each event that occurs in the mobile terminal 10, a format of the start-judgment condition is not limited to tables or functions. Further, one event identifier may be associated with plural start-necessitation conditions or start allowance conditions.

Further, an event exists that causes an application program to be started at any time according to a result of start-judgment.

For example, in the case where an event for turning an electronic power supply on and off for the mobile terminal 10 occurs, it is necessary to perform turning the electronic power supply on and off. For that reason, the start-judgment unit 104 starts at any time the application program for turning the electronic power supply on and off.

Further, in the case where an event for refereeing to information such as an outgoing call record or an address book of the mobile terminal 10 has occurred, the start-judgment unit 104 starts at any time the application program for refereeing the information.

The application program for refereeing to the information carries out merely displaying information and the like. For that reason, no interference occurs with processing of other application programs. Accordingly, in the case where the event for refereeing to the information has occurred, the start-judgment unit 104 judges that the application program to be notified of the event is to be started at any time, and the event is processed by the application program.

As described above, as to an event which needs to be processed at any time by the application program or an event which has no impact on other application programs when processed by the application program, the start-judgment unit 104 judges that the application program to be notified of the event is to be started at any time.

In other words, the start-unnecessitation condition associated with such events becomes blank. Or, the start allowance condition associated with such events becomes information that indicates all of the application programs included by the mobile terminal 10.

Further, it has been assumed in the present embodiment that the start-judgment unit 104 obtains an operational status of one or more than one application program from the status obtainment unit 106 and use the operational status for a start-judgment.

However, the start-judgment unit 104 may perform the start-judgment by using a status of the mobile terminal 10 other than the operational status of the application program.

The case where the mobile terminal 10 is a mobile phone that can transform the shape is assumed, for example the case of what is called a folding mobile terminal or a slide mobile terminal.

In this case, the status obtainment unit 106 may obtain information indicating what shape the mobile terminal 10 is, and the start-judgment unit 104 may use the information for the start-judgment.

Information indicating a state of the mobile terminal 10 other than the operational status of the application program includes the following.

Information indicating whether or not an external storage medium such as a SD card is inserted into the mobile terminal 10; information indicating an amount of space of an external storage medium such as a SD card inserted into the mobile terminal 10; information indicating an amount of charge of a battery of the mobile terminal 10; information indicating whether or not the mobile terminal 10 is on charge; information indicating whether or not an adapter is connected to the mobile terminal 10; information indicating whether or not the mobile terminal 10 is in a telepoint; information indicating whether or not the mobile terminal 10 is set to be, what is called, a manner mode, a drive mode or the like; information indicating whether or not a dial lock that prohibits an outgoing call is set to the mobile terminal 10; and the like is included.

The case is assumed, for example, an event has occurred, from the middleware 102, which is for an application program that processes only the data that is stored in the external storage medium.

In this case, the start-judgment unit 104 judges that the application program is not to be started by obtaining, from the status obtainment unit 106, that the external storage medium is not inserted in the mobile terminal 10, thereby enabling discarding the event.

Further, the case is assumed where, for example, the mobile terminal 10 receives a phone call when the mobile terminal 10 is set to be the drive mode.

In this case, the start-judgment unit 104 judges that the telephone application is not to be started, by obtaining, from the status obtainment unit 106, that the mobile terminal 10 is set to be the drive mode, thereby enabling discarding the event.

Further, the case is assumed where, for example, a user presses a dial button of the mobile terminal 10 when the dial lock is set to the mobile terminal 10.

In this case, the start-judgment unit 104 judges that the telephone application is not to be started, by obtaining, from the status obtainment unit 106, that the dial lock is set to the mobile terminal 10, thereby enabling discarding the event.

As described above, the system management apparatus 101 can appropriately judge, for each event, whether or not to start an application program to be notified of the event, by obtaining a status of the mobile terminal 10 other than the operational status of the application program. In other words, it is possible to immediately discard the event without unnecessarily starting the application program.

Further, the start-judgment unit 104 uses the operational status of each application program for a start-judgment in the present embodiment.

However, the start-judgment unit 104 may identify by which event the application program in operation is started, and use the operational status of the application program for each event as a judgment condition.

For example, in the case where the application program that has been started by an event for a user to view a TV program is in operation when an event of movie shooting occurs, the start-judgment unit 104 can judge that it is unnecessary to start the camera application associated with the event of movie shooting.

Further, an operational status of an application program immediately before an event occurrence may be added as information for start-judgment.

Further, it has been assumed that the event transmitted from the middleware 102 includes event information that is the data used for processing the event by the application program (see, FIG. 2).

However, in the case where a process of the application program is uniquely determined only with the event identifier and the like, it may be possible that event information is not included.

Further, the event transmitted from the middleware 102 may include, in addition to each information indicated in FIG. 2, other information such as information that indicates application program of the source of transmission.

Further, the system management apparatus 101 may include plural event storage units 103 in association with plural application programs.

In this case, it is possible to identify to which application program the event is directed, according to which event storage unit 103 stores the event. Accordingly, an application identifier does not necessarily have to be included in the event.

Further, the event storage unit 103 may hold the received event as it is, or may manage and hold by extracting necessary information. For example, an application identifier, an event identifier, and event information may be extracted from the event received from the middleware 102, and separately stored in association with each other.

Further, it may be possible for the event storage unit 103 not to be included in the system management apparatus 101. For example, in the case where the event transmitted from the middleware 102 is stored in a predetermined storage device included in the mobile terminal 10, the system management apparatus 101, as necessary, may read information such as the event identifier from the storage device, and delete the event from the storage device, and the like.

Further, it has been assumed that the status obtainment unit 106 collects an operational status of an application program after receiving a request from the start-judgment unit 104.

However, when the operational status of the application program changes, the status obtainment unit 106 may receive and store information of the change regardless of presence or absence of a request from the start-judgment unit 104.

In this case, the status obtainment unit 106 can hold information indicating a latest operational status at any time, by updating, according to the received information, information indicating operational status which has been held. Further, the information indicating a latest operational status can be transmitted in response to a request from the start-judgment unit 104.

### Second Embodiment

It has been assumed in the first embodiment that, in the case where an event has occurred, the middleware 102 notifies the start-judgment unit 104 of the event occurrence. Further, it has been assumed that the start-judgment unit 104 performs a start-judgment as triggered by receiving the notification.

However, it is not necessary for the middleware 102 to notify the start-judgment unit 104 of an event occurrence.

When the system management apparatus 101 can detect an event occurrence from the middleware 102 by some means, however, the start-judgment unit 104 can find the event occurrence and perform a start-judgment.

Accordingly, as a second embodiment of the present invention, a configuration and operations of the system management apparatus 101 will be described, which includes a unit that detects an event occurrence from the middleware 102.

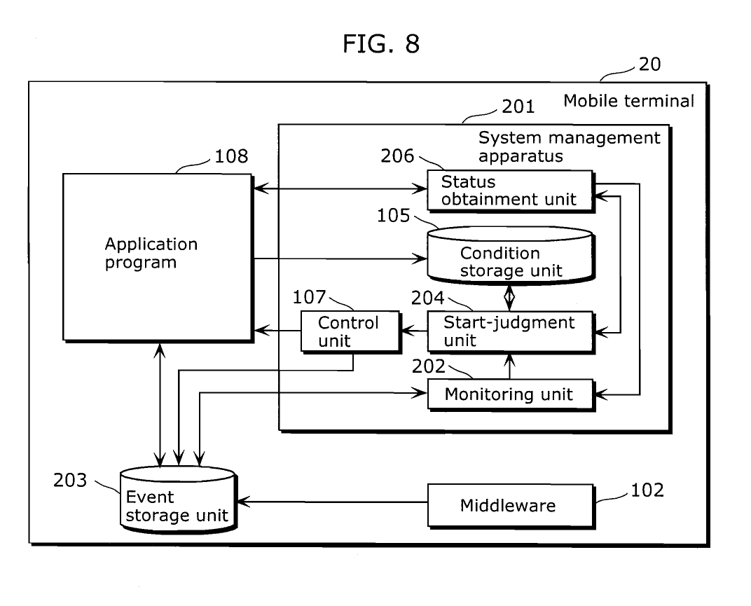

FIG. 8 is a functional block diagram illustrating a major functional configuration of a mobile terminal 20 according to a second embodiment of the present invention.

It is to be noted that, in FIG. 8, for the same elements as in the mobile terminal 20 of the first embodiment, the same numerals are applied and detailed descriptions thereof will be omitted.

The mobile terminal 20 according to the second embodiment includes a system management apparatus 201. The system management apparatus 201 is, as well as the system management apparatus 101 according to the first embodiment, an apparatus that manages and controls operations of equal to or more than one application programs included by the mobile terminal 20.

However, the system management apparatus 201 according to the second embodiment includes a monitoring unit 202 as a characteristic that the system management apparatus 101 according to the first embodiment does not include.

The monitoring unit 202 is a processing unit that monitors an event storage unit 203 and detects that an event is stored in the event storage unit 203.

It is to be noted that, a data structure of an event transmitted from the middleware 102 is the same as that of the event of the first embodiment (see, FIG. 2), and includes an event identifier, an application identifier, and the like.

Further, although the event storage unit 203, the start-judgment unit 204, and the status obtainment unit 206 are different, in that they exchange information with the monitoring unit 202, from the event storage unit 103, the start-judgment unit 104, and the status obtainment unit 106, respectively, according to the first embodiment, fundamental features are the same.

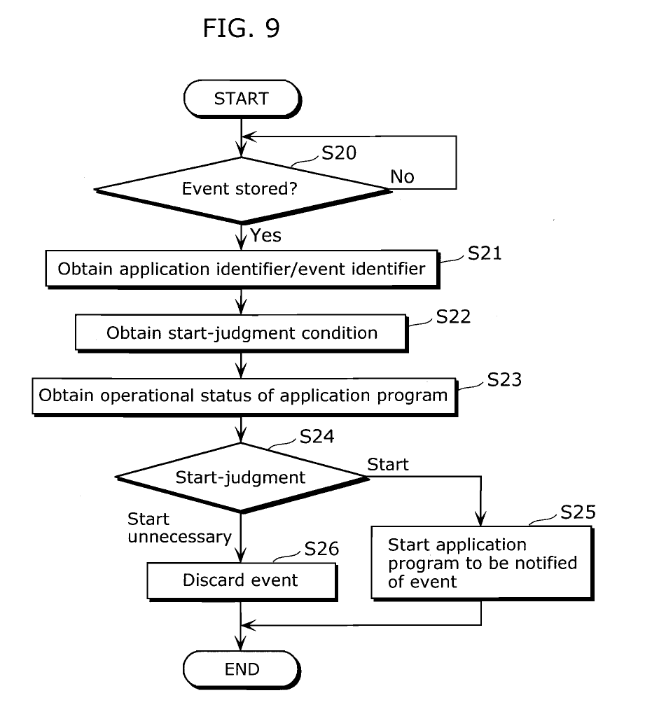

Operations of the system management apparatus 201 configured as described above, according to the second embodiment, will be described with reference to FIG. 9.

FIG. 9 is a flowchart illustrating operations of a start-judgment of the system management apparatus 201 according to the second embodiment.

While the monitoring unit 202 monitors event storage in the event storage unit 203 (S20), an event transmitted from the middleware 102 is stored in the event storage unit 203.

The monitoring unit 202, when it is detected that the event is stored in the event storage unit 203 (Yes, in S20), obtains, from the event storage unit 203, an application identifier and an event identifier included in the event and notifies the start-judgment unit 204 (S21).

It is to be noted that, an event to be monitored by the monitoring unit 202 is assumed to only be an event for an application program that is not started. Further, the monitoring unit 202 is notified a status of an application program (such as, running or ended) by the status obtainment unit 206.

The start-judgment unit 240 obtains a start-judgment condition (S22). More specifically, based on the application identifier and the event identifier notified by the monitoring unit 202, a start-unnecessitation condition that is associated with the application identifier and the event identifier is obtained from the condition storage unit 105.

The start-judgment unit 204 further obtains an operational status of one or more than one application program at the time from the status obtainment unit 206 (S23).

More specifically, when receiving a request for obtaining the operational state of the application program from the start-judgment unit 204, the status obtainment unit 206 notifies each of the application programs of the request for obtaining the operational status.

When each operational status is obtained from each of the application programs, the status obtainment unit 206 notifies the start-judgment unit 204 of the operational status of application programs of each of the application programs.

The start-judgment unit 204 judges whether or not to start the application program to be notified of the event, according to whether or not the notified operational status satisfies the obtained start-judgment condition (S24).

For example, the case is assumed where the event is an event of movie shooting and the TV application is in operation when the event occurs.

In this case, the start-judgment unit 204, since the start-unnecessitation condition associated with the event of movie shooting is “TV” (see, FIG. 3), judges that the camera application to be notified of the event of movie shooting is not to be started (start unnecessary in S24).

The control unit 107 receives a result of the judgment and discards the event of movie shooting stored in the event storage unit 203 without starting the camera application (S26).

It is to be noted that, in the case where the event of movie shooting occurs and the TV application is not in operation at the time, the start-judgment unit 204 judges that the camera application is to be started since the case does not satisfy the start-unnecessitation condition (start in S24).

The control unit 107 receives a result of the judgment and starts the camera application (S25). The camera application, when started, obtains the event of movie shooting from the event storage unit 203 and processes the event.

Further, in the case where the start-judgment unit 204 has judged that the application program is to be started and the application program is started as described above, the monitoring unit 202 suspends notifying the event identifier associated with the application program to the start-judgment unit 204.

This is because the start-judgment unit 204 does not have to carry out start-judgment since the application program has already been started.

Subsequently, the status obtainment unit 206, when the application program comes to the end, notifies the monitoring unit 202 that the application program has ended.

The monitoring unit 202, when notified by the status obtainment unit 206 that the application program has ended, resume notification, to the start-judgment unit 204, of the event identifier associated with the application program.

As described above, the system management apparatus 201 according to the second embodiment, when an event occurs in the information processing system, can judge whether or not to start an application program which is to be notified of the event.

With this, it is possible to immediately discard the event without unnecessarily starting the application program.

Thus, the system management apparatus 201 according to the second embodiment, as well as the system management apparatus 101 according to the first embodiment, can make an application program work efficiently in the information processing system, thereby reducing processing load of the information processing system. Further, it is possible to make the information processing system efficiently use memory and the like in which an event is to be stored.

Further, the system management apparatus 201 according to the second embodiment includes a monitoring unit 202. The monitoring unit 202 can detect an event occurrence from the middleware 102 by monitoring the event storage unit 203.

This enables, in the information processing system, reducing processes for notifying the system management apparatus 201 of an event occurrence from a middleware 102 (for example, generation processing and transmission processing of event notification in the middleware 102, and reception processing of event notification in the system management apparatus 201), thereby shortening processing time.

It is to be noted that, in the system management apparatus 201 according to the second embodiment, the event storage unit 203 is not included in the system management apparatus 201 as illustrated in FIG. 8. However, the event storage unit 203 may be included in the system management apparatus201.

More specifically, an arrangement position of the event storage unit 203 is not limited as long as each component such as the monitoring unit 202 can exchange information with the event storage unit 203 as necessary.

Further, the event storage unit 203 may hold the received event as it is, or may manage and hold by extracting necessary information.

Further, plural event storage units 203 may be provided in association with plural application programs included in the mobile terminal 20, and the monitoring unit 202 may monitor the event storage unit 203 that is associated with a transit application program.

Here, the transit application program is an application program that is started as necessary in response to a request for start from a menu by user operation and the like. Further, an application program that is running all the time an electronic power supply of the mobile terminal 20 is on is called a resident application program.

Further, the status obtainment unit 206, when an operational status of the application program changes, may receive and hold information of the change regardless of presence or absence of a request from the start-judgment unit 204. Further, the information indicating the operational status that is held may be updated according to the information that has been received.

With this, the status obtainment unit 206 can hold information indicating a latest operational status at any time. Further, the information indicating the latest operational status can be transmitted in response to a request from the start-judgment unit 204.

Further, both of the system management apparatus 101 according to the first embodiment and the system management apparatus 201 according to the second embodiment are included in a mobile terminal, and manage the mobile terminal.

However, the information processing system managed by the system management apparatus of the present invention is not limited to mobile terminals.

To be specific, as long as the information processing system includes a hardware or a software which has an execution environment for an application program, the system management apparatus of the present invention can make an application program work efficiently.

Further, operations of each component of both of the system management apparatus 101 according to the first embodiment and the system management apparatus 201 according to the second embodiment can be embodied by a computer that includes a central processing unit (CPU), a storage device, an interface for inputting and outputting information, and the like.

For example, a CPU reads an application identifier and an event identifier from the event storage unit 103 via an interface. Further, the CPU identifies an operational status of one or more than one application program at the time.

Furthermore, the identified operational status and a start-judgment condition that is associated with the event identifier read from the condition storage unit 105 are compared, and start-judgment for the application program that is associated with the application identifier is carried out.

Further, the application program is started according to result of the judgment. Or, the event is discarded without starting the application program.

With operations of such a computer as well, operations of the system management apparatus of the present invention can be embodied and a system management method of the present invention can be carried out.

Further, the functional blocks included in the system management apparatus of the present invention are typically implemented as an LSI which is an integrated circuit. Further, these functional blocks may be integrated separately, or a part or all of them may be integrated into a single chip.

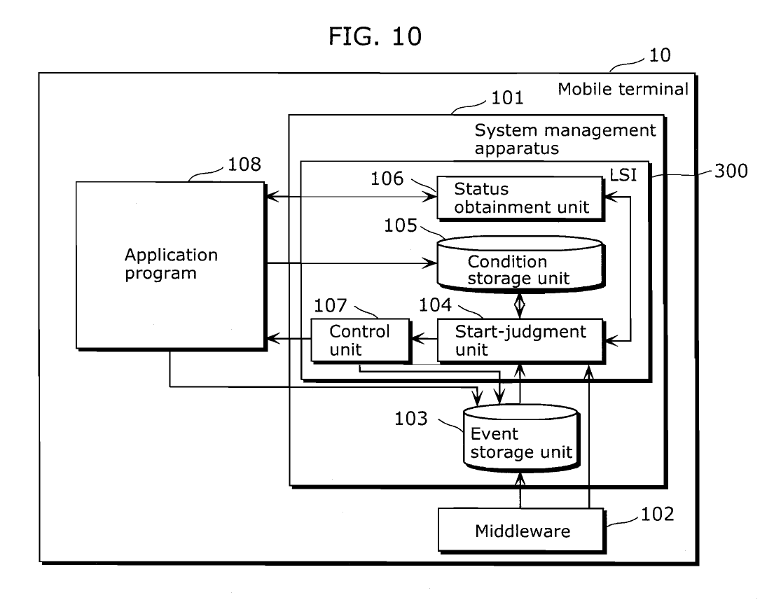

FIG. 10 is a diagram illustrating an example of an integrated circuit used for a system management apparatus 101 according to the first embodiment.

An LSI 300 illustrated in FIG. 10 is an example of an integrated circuit, and the range of functional blocks included in the LSI 300 is an example of the range of components which are integrated.

It is to be noted that, the LSI here can be referred to as an IC, a system LSI, a super LSI, or an ultra LSI, depending on the degree of integration.

Further, an integrated circuit is not limited to an LSI, and it may be embodied as a dedicated circuit or a general-purpose processor. It is also possible to use a field programmable gate array (FPGA) which can be programmed in the field after manufacturing an LSI, or a reconfigurable processor in which connection and setting of circuit cells inside an LSI can be reconfigured.

Furthermore, when a technology for the integrated circuit replacing LSI is developed with the advance of semiconductor technology or relevant technology, functional blocks can be integrated using the technology. Possible field of technology to be applicable includes, for example, bio technology and the like.

It is to be noted that, each of the functional blocks in the system management apparatus 201 according to the second embodiment as illustrated in FIG. 8 may also be integrated separately, or a part or all of them may be integrated into a single chip.

### INDUSTRIAL APPLICABILITY

The system management apparatus of the present invention can appropriately control start of application programs included in the information processing system and make the application programs work efficiently. The result produces an advantage that power consumption is reduced. Accordingly, the system management apparatus of the present invention is useful as a system management apparatus in a information processing system such as a mobile phone, a personal digital assistance (PDA), and the like.

1. A system management apparatus which manages an information processing system capable of executing an application program, said system management apparatus comprising:
an event obtainment unit configured to obtain, from a storage unit in which an event corresponding to the application program is stored, an event identifier that identifies the event, the storage unit being included in the information processing system;
a status obtainment unit configured to obtain a status of the information processing system;
a control unit configured to adaptively start the application program; and
a judgment unit configured to judge whether or not to start the application program depending on whether or not the obtained status of the information processing system satisfies a start-judgment condition associated with the obtained event identifier,
wherein said control unit is configured to discard the event stored in the storage unit without starting the application program in the case where said judgment unit judges that the application program is not to be started.

2. The system management apparatus according to claim 1, further comprising
a condition storage unit configured to store a start-judgment condition associated with a corresponding one of event identifiers of plural types,
wherein the start-judgment condition includes information indicating the status of the information processing system, the information being a condition for whether or not to start the application program, and
said judgment unit is configured:
to obtain, from said condition storage unit, the start-judgment condition associated with the event identifier obtained by said event obtainment unit; and
to judge whether or not to start the application program depending on whether or not the status of the information processing system obtained by said status obtainment unit matches the status of the information processing system indicated by the start-judgment condition obtained from said condition storage unit.

3. The system management apparatus according to claim 2,
wherein the information that indicates the status of the information processing system and that is included in the start-judgment condition is information indicating an operational status of a predetermined application program,
said status obtainment unit is configured to obtain, from the application program or another application program, an operational status of the application program or the other application program, and
said judgment unit is configured to judge whether or not to start the application program to be notified of the event, depending on whether or not the operational status obtained by said status obtainment unit matches the operational status, of the predetermined application program, indicated by the start-judgment condition obtained from said condition storage unit.

4. The system management apparatus according to claim 3,
wherein the start-judgment condition is a condition for not starting the application program to be notified of the event in the case where the predetermined application program is in operation, and
said judgment unit is configured to judge that the application program to be notified of the event is not to be started in the case where the operational status obtained by said status obtainment unit indicates that the predetermined application program is in operation.

5. The system management apparatus according to claim 2,
wherein said condition storage unit, in the case where an application program is added to the information processing system, is configured to further store a start-judgment condition regarding the application program in response to a request from the added application program.

6. The system management apparatus according to claim 1, further comprising a monitoring unit configured to detect that the event has been stored in said event storage unit,
wherein said judgment unit is configured to judge whether or not to start the application program, when notified by said monitoring unit that the event has been stored in said event storage unit.

7. A system management method for managing an information processing system capable of executing an application program, said system management method comprising:
obtaining, from a storage unit in which an event corresponding to the application program is stored, an event identifier that identifies the event, the storage unit being included in the information processing system;
obtaining a status of the information processing system;
starting adaptively the application program; and
judging whether or not to start the application program depending on whether or not the obtained status of the information processing system satisfies a start-judgment condition associated with the obtained event identifier,
wherein, in said starting, the event stored in the storage unit is discarded without the application program being started, in the case where it is judged in said judging that the application program is not to be started.

8. A program for managing an information processing system capable of executing an application program, said program causing a computer to execute:
obtaining, from a storage unit in which an event corresponding to the application program is stored, an event identifier that identifies the event, the storage unit being included in the information processing system;
obtaining a status of the information processing system;
starting adaptively the application program; and
judging whether or not to start the application program depending on whether or not the obtained status of the information processing system satisfies a start-judgment condition associated with the obtained event identifier,
wherein, in said starting, the event stored in the storage unit is discarded without the application program being started, in the case where it is judged in said judging that the application program is not to be started.
